(19) United States
(12) Patent Application Publication
(10) Pub. No.: US 2015/0295347 A1
(43) Pub. Date: Oct. 15, 2015

(54) CONNECTOR AND ELECTRONIC DEVICE PROVIDED WITH SAME

(71) Applicant: HOSIDEN CORPORATION, Yao-shi (JP)

(72) Inventors: Takayuki Nagata, Yao-shi (JP); Ryuhei Kato, Yao-shi (JP); Yutaka Uno, Yao-shi (JP)

(73) Assignee: Hosiden Corporation, Yao-shi (JP)

(21) Appl. No.: 14/425,914

(22) PCT Filed: Sep. 5, 2013
(86) PCT No.: PCT/JP2013/073862

§ 371 Date: Mar. 4, 2015

(30) Foreign Application Priority Data
Sep. 7, 2012 (JP) 2012-196800

(51) Int. Cl. H01R 13/52; H01R 24/58; H01R 13/11

(52) U.S. Cl. CPC H01R 13/5216; H01R 13/111; H01R 24/58; H01R 2107/00

(57) ABSTRACT

[Purpose] The invention provides a connector capable of suppressing plastic deformation of a contact portion of a contact and also provides an electronic device provided with the connector.

[Configuration] A connector C includes a first contact 200a, a second contact 200b in spaced relation to the first contact 200a along a first direction X, and a first stop 300a having an insulation property. The first contact 200a includes a contact portion 220a that is elastically deformable toward the second contact 200b. The first stop 300a is disposed between the first and second contacts 200a, 200b and on an elastic deformation direction side of the contact portion 220a so as to be abuttable on the contact portion 220a.

### TECHNICAL FIELD

The invention relates to connectors and electronic devices with the connectors.

### BACKGROUND ART

A conventional jack connector is described in Patent Literature 1. The connector includes a body and a plurality of contacts. The body has a connection hole adapted to receive a plug (mating connector). The contacts are arranged, in spaced relation to each other, on either side in a first direction in the connection hole of the body. The contacts each include an elastically deformable contact portion.

### CITATION LIST

### Patent Literature

Patent Literature 1: Japanese published utility model application No. 49-135788

### SUMMARY OF INVENTION

### Technical Problem

In the above connector, when a plug as received in the connection hole of the body is pried in the first direction so as to press the contact portions of the contacts, the pressed contact portions may be displaced beyond a predetermined displacement range and thereby plastically deformed.

The invention has been conceived in view of the above circumstances. An object of the invention is to provide a connector capable of suppressing plastic deformation of contact portions of contacts and to provide an electronic device provided with the connector.

### Solution to Problem

To solve the above problem, a connector of the invention includes a first contact, a second contact, and a first stop having an insulation property. The second contact is disposed in spaced relation to the first contact along a first direction. The first contact includes a contact portion, the contact portion being elastically deformable toward the second contact. The first stop is disposed between the first and second contacts and on an elastic deformation direction side of the contact portion so as to be abuttable on the contact portion.

In the connector of this aspect, when the contact portion of the first contact elastically deforms, the contact portion abuts on the first stop and therefore will not be displaced beyond a predetermined displacement range. Therefore, it is possible to inhibit the contact portion of the first contact from being displaced beyond the predetermined displacement range and thereby plastically deformed even when the mating connector is pried so as to press the contact portion. In addition, the first stop is interposed between the first and second contacts. This arrangement can reduce the possibility of upsizing the connector because of the inclusion of the first stop. Further, the first stop, having an insulation property, can prevent electrical connection between the first and second contacts via the interposed first stop.

The first stop may include a base and an abuttable portion. The base may be interposed between the first and second contacts. The abuttable portion may be contiguous with the base and disposed on the elastic deformation direction side of the contact portion so as to be abuttable on the contact portion. The abuttable portion may have a dimension in the first direction that differs from that of the base.

The connector of this aspect makes it possible to define a displacement range of the contact portion of the first contact simply by differentiating the dimension in the first direction of the abuttable portion different from that of the base.

The connector may further include the body. The body may hold the first and second contacts in spaced relation to each other along the first direction.

The connector may further include a cover. The body may have a connection hole extending in a second direction through the body. The second direction may be orthogonal to the first direction. The first stop may be contiguous with the cover and extend to a first side of the second direction. The cover may block a portion on a second side of the second direction of the connection hole.

In the connector of this aspect, the cover blocking the portion on the second side of the second direction of the connection hole can improve waterproofing and dustproofing properties of the connector. In addition, as the first stop is contiguous with the cover, it is possible to interpose the first stop between the first and second contacts when blocking the portion on the second side of the second direction of the connection hole with the cover. It is thus possible to mount the first stop with ease.

The connector may further include a cover. The first stop may be contiguous with the cover and extend to a first side of a second direction. The second direction may be orthogonal to the first direction. The body may have a connection hole, and a first fitting hole on a second side of the second direction relative to the connection hole. The first fitting hole may communicate with the connection hole. The cover may fittingly engage with the first fitting hole and may block a portion on the second side of the second direction of the connection hole.

In the connector of this aspect, the cover fittingly engages with the first fitting hole and blocks the portion on the second side of the second direction of the connection hole. This arrangement can improve waterproofing and dustproofing properties of the connector. In addition, as the first stop is contiguous with the cover, it is possible to interpose the first stop between the first and second contacts when blocking the portion on the second side of the second direction of the connection hole with the cover. It is thus possible to mount the first stop with ease.

The first contact may further include a fixed portion. The fixed portion may have a hole. The contact portion may be contiguous with an edge of the hole of the fixed portion. The contact portion may be elastically deformable toward the second contact so as to be received into the hole and abuttable on the first stop.

In the connector of this aspect, when the contact portion elastically deforms toward the second contact, the contact portion is received in the hole of the fixed portion and abuts on the first stop. This arrangement can reduce the lengthwise dimension of the first stop contiguous with the cover. This further reduces the possibility of upsizing the connector because of the inclusion of the first stop.

The connector may further include a seal. The body may further have a second fitting hole on the second side of the second direction relative to the first fitting hole. The second fitting hole may communicate with the first fitting hole. The seal may be a resin being filled in the second fitting hole and overlying the cover.

In the connector of this aspect, the seal, being a resin being filled in the second fitting hole and overlying the cover, can improve waterproofing and dustproofing properties of the connector.

The cover may include a projection projecting to the second side of the second direction. The projection may be embedded in the seal.

In the connector of this aspect, the projection of the cover, embedded in the seal, can improve the degree of adhesion of the cover to the seal.

The connector may further include a third contact, a forth contact, a fifth contact, a sixth contact, and a second stop having an insulation property. The second, third, fourth, fifth, and sixth contacts may each include a contact portion. The fourth, fifth, and sixth contacts may be arranged, in spaced relation to each other along the first direction, at positions in the body that are on a first side of the first direction relative to the connection hole, and the contact portions of the fourth, fifth, and sixth contacts may be arranged in the connection hole, in spaced relation to each other along the second direction. The first, second, and third contacts may be arranged, in spaced relation to each other along the first direction, at positions in the body that are on a second side of the first direction relative to the connection hole, and the contact portions of the first, second, and third contacts may be arranged inside the connection hole, in spaced relation to each other along the second direction. The contact portion of the fourth contact may be elastically deformable toward the fifth contact. The second stop may be disposed between the fourth contact and the fifth contact and on an elastic deformation direction side of the contact portion of the fourth contact so as to be abuttable on the contact portion of the fourth contact.

In the connector of this aspect, when the contact portion of the fourth contact elastically deforms, the contact portion of the fourth contact abuts on the second stop. This prevents the contact portion of the fourth contact from being displaced beyond a predetermined amount. This can inhibit the contact portion of the fourth contact from being displaced beyond the predetermined displacement range and thereby plastically deformed even when the mating connector is pried so as to press the contact portion. In addition, the second stop is interposed between the fourth and fifth contacts. This arrangement can reduce the possibility of upsizing the connector because of the inclusion of the second stop. Further, the second stop, having an insulation property, can prevent electrical connection between the fourth and fifth contacts via the interposed second stop.

The electronic device of the invention is provided with the connector of any of the above aspects.

### BRIEF DESCRIPTION OF DRAWINGS

FIG. 1A is a perspective view of a connector according to an embodiment of the invention as viewed from the front, top, right side of the connector;

FIG. 1B is a perspective view of the connector as viewed from the rear, bottom, left side thereof;

FIG. 2A is a cross-sectional view of the connector taken along line 2A-2A in FIG. 1A;

FIG. 2B is a cross-sectional view of the connector taken along line 2B-2B in FIG. 1A;

FIG. 3A is a cross-sectional view of the connector taken along line 3A-3A in FIG. 1A;

FIG. 3B is a cross-sectional view of the connector taken along line 3B-3B in FIG. 1A;

FIG. 4A is a perspective view of a cover and first and second stops of the connector as viewed from the front, top right side thereof;

FIG. 4B is a perspective view of the cover and the first and second stops of the connector as viewed from the rear, bottom, right side thereof;

FIG. 5A is a perspective view of first to sixth contacts of the connector as viewed from the front, top, right side thereof;

FIG. 5B is a perspective view of the first to sixth contacts of the connector as viewed from the rear, bottom, left side thereof;

FIG. 6A is a cross-sectional view of the connector taken along line 2A-2A in FIG. 1A, with a plug inserted in the connector; and

FIG. 6B is a cross-sectional view of the connector taken along line 2B-2B in FIG. 1A, with the plug inserted in the connector.

### MODE(S) FOR CARRYING OUT THE INVENTION

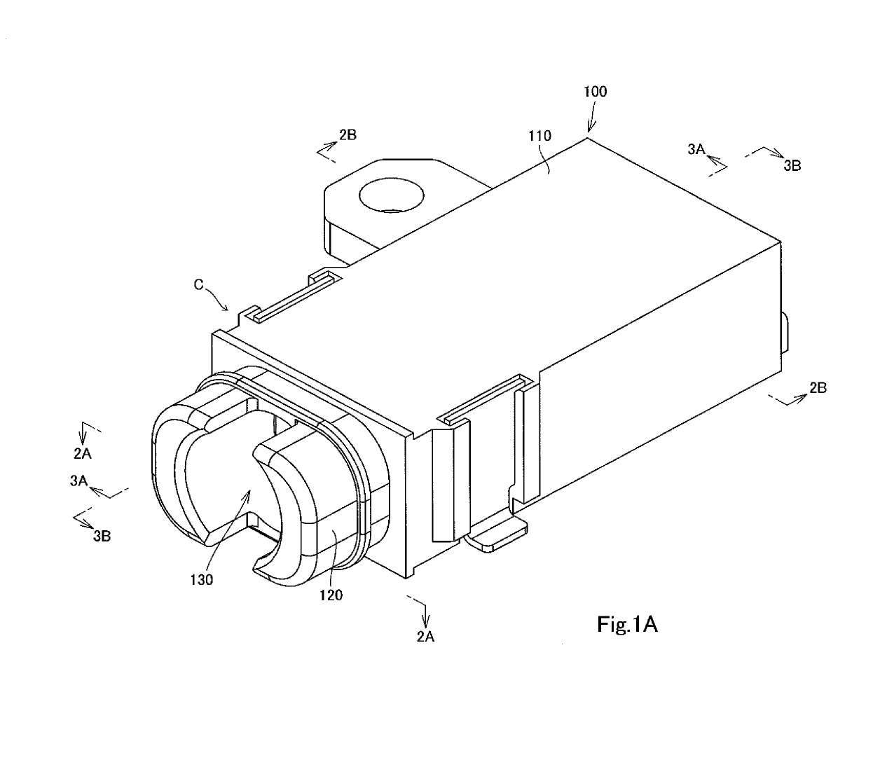

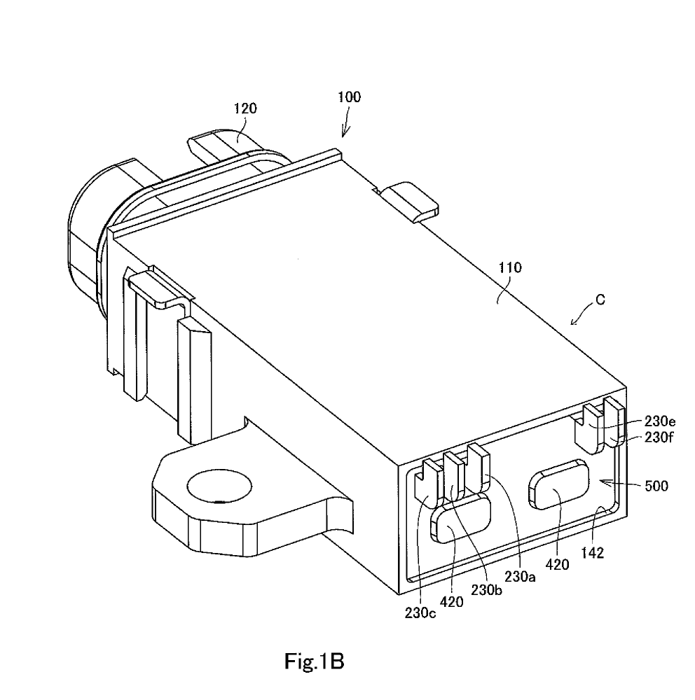

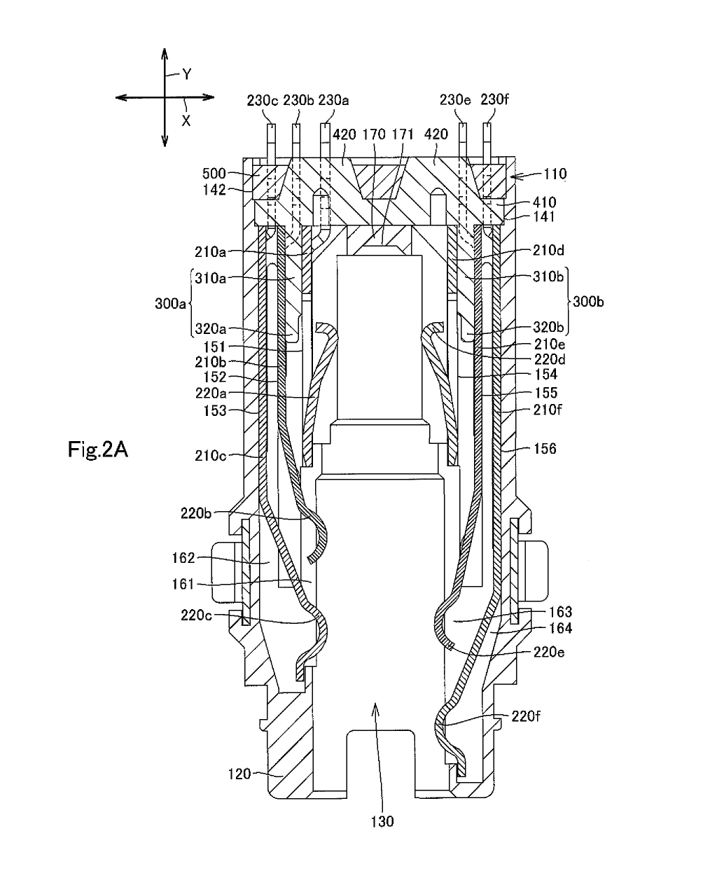

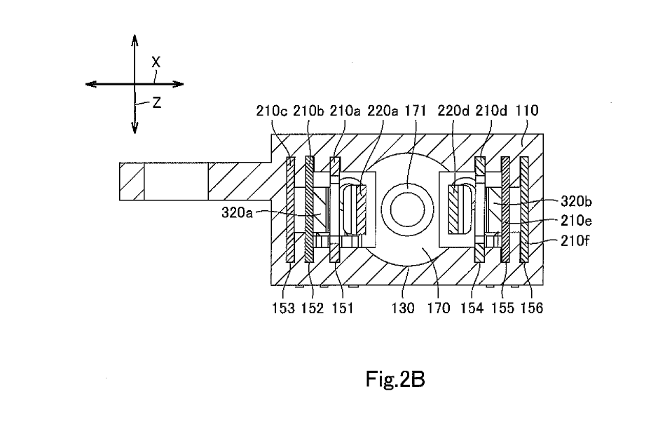

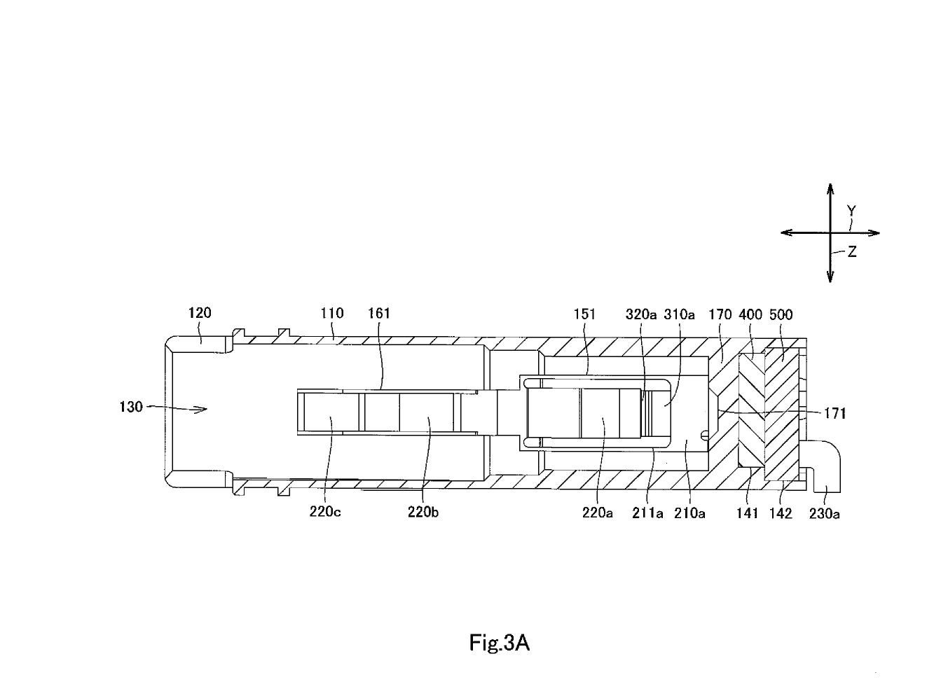

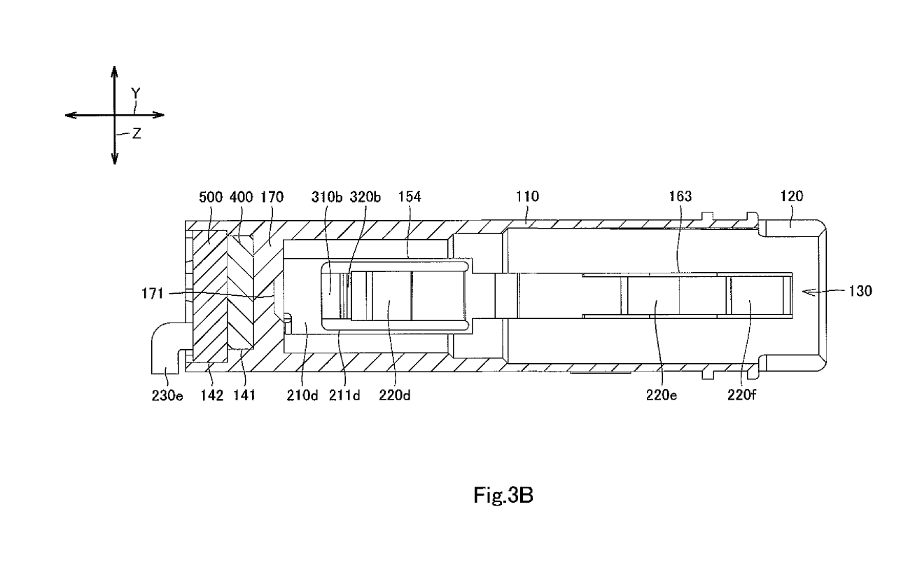

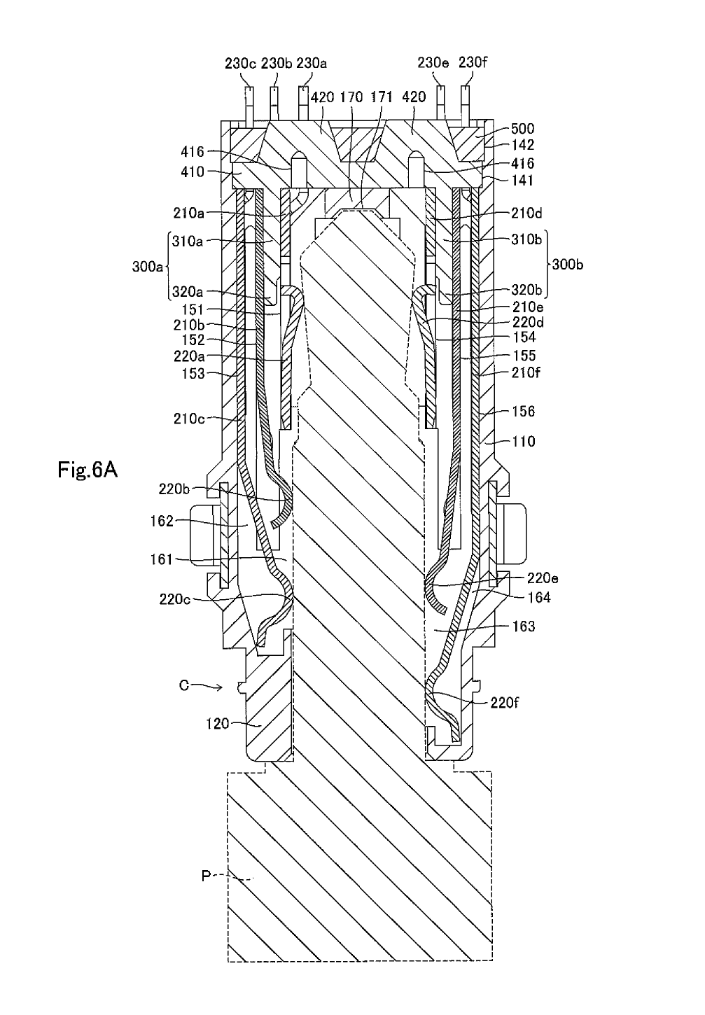

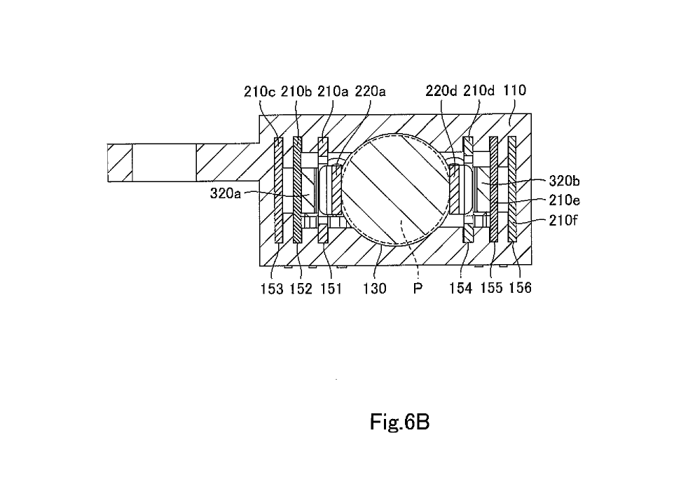

A connector C according to an embodiment of the invention will be described below with reference to FIGS. 1A to 6B. The connector C illustrated in FIGS. 1A and 1B is a multi-contact jack connector, which is connectable with a plug P (a mating connector, see FIGS. 6A and 6B). As illustrated in FIGS. 2A to 3B, the connector C includes a body 100, a first contact 200a, a second contact 200b, a third contact 200c, a fourth contact 200d, a fifth contact 200e, a sixth contact 200f, a first stop 300a, a second stop 300b, a cover 400, and a seal 500. These constituents of the connector C will be described below in detail. FIGS. 2A and 2B show a first direction X, which is the widthwise direction of the connector C. FIGS. 2A, 3A, and 3B show a second direction Y, which is the lengthwise direction of the connector C. FIGS. 2A, 3A, and 3B show a third direction Z, which is the heightwise direction of the connector C. The second direction Y is orthogonal to the first direction X. The third direction Z is orthogonal to the first direction X and the second direction Y.

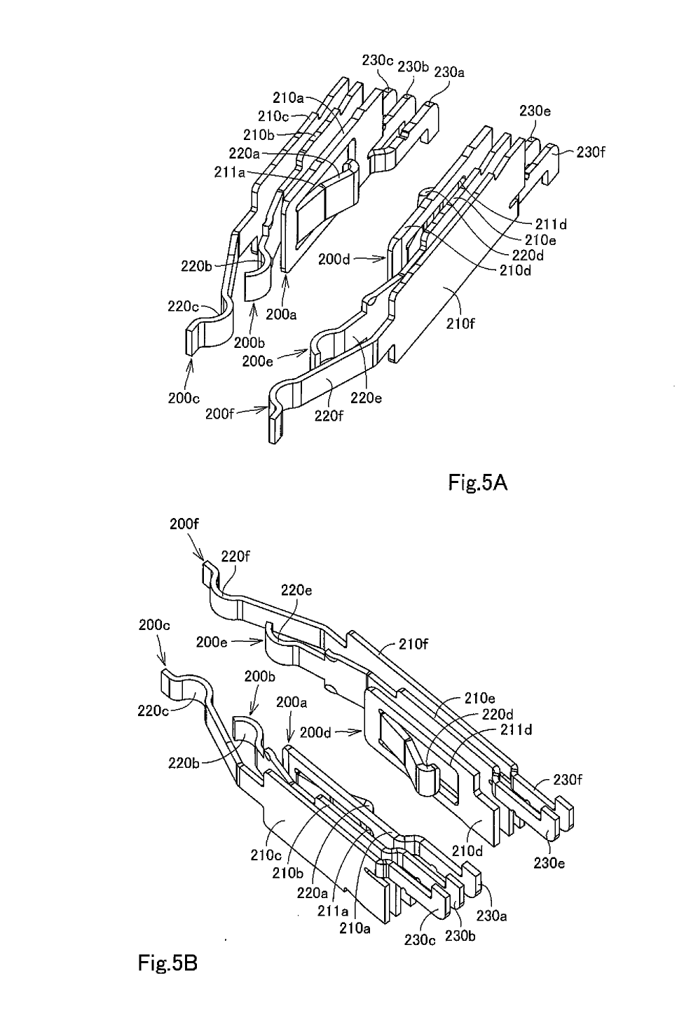

As illustrated in FIGS. 2A, 2B, 5A, and 5B, the first contact 200a is a plate metal formed by stamping. The first contact 200a includes a fixed portion 210a, a contact portion 220a, and a tail 230a.

As illustrated in FIGS. 2A, 5A, and 5B, the fixed portion 210a is a plate extending in the second direction Y, including first and second ends in the second direction Y (front and rear ends) and a rectangular hole 211a. The hole 211a has first and second edges in the second direction Y. The contact portion 220a is a plate contiguous with the first edge of the hole 211a and extends to a second side of the second direction (extends rearwards) with an inclination to a first side of the first direction X. The contact portion 220a is elastically deformable to a second side of the first direction X (i.e., toward the second contact). The contact portion 220a as elastically deforming can enter into the hole 211a. The distal portion of the contact portion 220a is curved in a circular arc shape bowed to the first side of the first direction X. The tail 230a is a generally L-shaped plate contiguous with a lower part of the second end of the fixed portion 210a.

As illustrated in FIGS. 2A, 2B, 5A, and 5B, the second contact 200b is a plate metal formed by stamping. The second contact 200b includes a fixed portion 210b, a contact portion 220b, and a tail 230b.

As illustrated in FIGS. 2A, 5A, and 5B, the fixed portion 210b is a plate extending in the second direction Y and including first and second ends in the second direction Y (front and rear ends). The contact portion 220b is a plate contiguous with the first end of the fixed portion 210b and extends to a first side of the second direction Y (extends frontwards) with an inclination to the first side of the first direction X. The contact portion 220b is elastically deformable to the second side of the first direction X. The distal portion of the contact portion 220b is curved in a circular arc shape bowed to the first side of the first direction X. The tail 230b is a generally L-shaped plate contiguous with a lower part of the second end of the fixed portion 210b.

As illustrated in FIGS. 2A, 2B, 5A, and 5B, the third contact 200c is a plate metal formed by stamping. The third contact 200c includes a fixed portion 210c, a contact portion 220c, and a tail 230c.

As illustrated in FIGS. 2A, 5A, and 5B, the fixed portion 210c is a plate extending in the second direction Y and including first and second ends in the second direction Y (front and rear ends). The fixed portion 210c is larger in dimension in the second direction Y than the fixed portion 210b is. The contact portion 220c is a plate contiguous with the first end of the fixed portion 210c, extending to the first side in the second direction Y (extends frontwards) with an inclination to the first side of the first direction X. The contact portion 220c is larger in dimension in the second direction Y than the contact portion 220b is. The contact portion 220c is elastically deformable to the second side of the first direction X. The distal portion of the contact portion 220c is curved in a circular arc shape bowed to the first side of the first direction X. The tail 230c is a generally L-shaped plate contiguous with a lower part of the second end of the fixed portion 210c.

As illustrated in FIGS. 2A, 5A, and 5B, the fourth contact 200d is a plate metal formed by stamping. The fourth contact 200d differs from the first contact 200a in being a mirror image of the first contact 200a and having no tail portion. Except for these, the fourth contact 200d has substantially the same shape as the first contact 200a. As illustrated in FIGS. 2A, 5A to 6B, the fourth contact 200d includes a fixed portion 210d and a contact portion 220d. The contact portion 220d is elastically deformable to the first side of the first direction (i.e., toward the fifth contact). The contact portion 220d as elastically deforming can enter into a hole 211d.

As illustrated in FIGS. 2A, 5A, and 5B, the fifth contact 200e is a plate metal formed by stamping. The fifth contact 200e has substantially the same shape as the second contact 200b except for the following two differences. The first difference is that the fifth contact 200e is a mirror image of the second contact 200b. The second difference is that the fixed portion 210e and the contact portion 220e are respectively larger in dimension in the second direction Y than the fixed portion 210b and the contact portion 220b are. As illustrated in FIGS. 2A, and 5A to 6B, the fifth contact 200e includes a tail 230e.

As illustrated in FIGS. 2A, 5A, and 5B, the sixth contact 200f is a plate metal formed by stamping. The sixth contact 200f has substantially the same shape as the third contact 200c except for the following two differences. The first difference is that the sixth contact 200f is a mirror image of the third contact 200c. The second difference is that the fixed portion 210f and the contact portion 220f are respectively larger in dimension in the second direction Y than the fixed portion 210c and the contact portion 220c are. As illustrated in FIGS. 2A, and 5A to 6B, the sixth contact 200f includes a tail 230f.

The body 100 is made of an insulating resin. As illustrated in FIGS. 2A to 3B, the body 100 includes a main body 110, a projected part 120, a connection hole 130, first and second fitting holes 141 and 142, housing grooves 151, 152, 153, 154, 155, and 156, housing holes 161, 162, 163, and 164, and a holding part 170. The main body 110 is a rectangular parallelepiped block having a front face (first end face in the second direction Y) and a rear face (second end face in the second direction Y). The projected part 120 is an elliptic cylinder projecting from the front face of the main body 110.

As illustrated in FIGS. 2A to 3B, the connection hole 130 and the first and second fitting holes 141 and 142 extend in the second direction Y through the main body 110 and the projected part 120. The connection hole 130 extends in the second direction Y inside the main body 110 and the projected part 120, opening in the front face of the projected part 120 to the first side of the second direction Y. The connection hole 130 can receive the plug P. The holding part 170 is provided centrally in an area on the second side of the second direction Y of the connection hole 130. The holding part 170 is a plate extending between inner faces on the first and second sides of the third direction Z of the connection hole 130. The holding part 170 has a generally circular holding hole 171. The holding hole 171 can fittingly receive the distal portion of the plug P. The first fitting hole 141 is a rectangular hole in the main body 110, more particularly at a portion thereof on the second side of the second direction Y relative to the connection hole 130. The first fitting hole 141 communicates with the connection hole 130 and has larger outer dimensions than the connection hole 130. The second fitting hole 142 is a rectangular hole in the main body 110, more particularly at a portion thereof on the second side of the second direction Y relative to the first fitting hole 141. The second fitting hole 142 communicates with the first fitting hole 141 and has larger outer dimensions than the first fitting hole 141. The second fitting hole 142 opens in the rear face of the main body 110 to the second side of the second direction Y.

As illustrated in FIG. 2A, the housing grooves 151, 152, and 153 are provided in spaced relation to each other along the first direction X in the body 100, at positions on the second side of the first direction X relative to the connection hole 130. The housing hole 161 is provided in the body 100, at a position on the first side of the second direction Y (on the front side) relative to the housing grooves 151 and 152. The housing hole 162 is provided in the body 100, at a position on the first side of the second direction Y (on the front side) relative to the housing groove 153. The housing grooves 154, 155, and 156 are provided in spaced relation to each other along the first direction X in the body 100, at positions on the first side of the first direction X relative to the connection hole 130. The housing hole 163 is provided in the body 100, at a position on the first side of the second direction Y (front side) relative to the housing grooves 153 and 154. The housing hole 164 is provided in the body 100, at a position on the first side of the second direction Y (front side) relative to the housing groove 156. Specific arrangements will be described below.

As illustrated in FIGS. 2A and 2B, the housing groove 151 is provided in the body 100, at a position on the second side of the first direction X relative to the connection hole 130. The housing groove 151 extends in the second direction Y and communicates with the connection hole 130. The housing groove 151 is slightly larger in dimension in the second direction Y than the fixed portion 210a of the first contact 200a. The housing groove 151 is slightly smaller in dimension in the third direction Z than the fixed portion 210a of the first contact 200a. The fixed portion 210a is press-fitted and held in the housing groove 151. The contact portion 220a of the first contact 200a is disposed in the connection hole 130.

As illustrated in FIGS. 2A and 2B, the housing groove 152 is provided in the body 100, at a position on the second side of the first direction X relative to the housing groove 151 with a space therebetween. The housing groove 152 extends in the second direction Y and communicates with the housing groove 151. The housing groove 152 is slightly larger in dimension in the second direction Y than the fixed portion 210b of the second contact 200b. The housing groove 152 is slightly smaller in dimension in the third direction Z than the fixed portion 210b of the second contact 200b. The fixed portion 210b is press-fitted and held in the housing groove 152.

As illustrated in FIGS. 2A and 3A, the housing hole 161 is provided in the body 100, at a position on the first side of the second direction Y (front side) relative to the housing grooves 151 and 152. The housing hole 161 is a horizontal hole extending in the second direction Y and communicating with the housing grooves 151 and 152 and the connection hole 130. The contact portion 220b of the second contact 200b is received in the housing hole 161. The distal portion of the contact portion 220b is disposed in the connection hole 130. The distal portion of the contact portion 220b is located on the first side of the second direction Y relative to the distal portion of the contact portion 220a of the first contact 200a.

As illustrated in FIGS. 2A and 2B, the housing groove 153 is provided in the body 100, at a position on the second side of the first direction X relative to the housing groove 152 with a space therebetween. The housing groove 153 extends in the second direction Y and communicates with the housing groove 152. The housing groove 153 is slightly larger in dimension in the second direction Y than the fixed portion 210c of the third contact 200c. The housing groove 153 is slightly smaller in dimension in the third direction Z than the fixed portion 210c of the third contact 200c. The fixed portion 210c is press-fitted and held in the housing groove 153.

The housing hole 162 is provided in the body 100, at a position on the first side of the second direction Y (on the front side) relative to the housing groove 153. The housing hole 162 is a horizontal hole extending in the second direction Y and communicating with the housing groove 153 and the housing hole 161. The contact portion 220c of the third contact 200c is received in the housing holes 161 and 162. The distal portion of the contact portion 220c is disposed in the connection hole 130. The distal portion of the contact portion 220c is located on the first side of the second direction Y relative to the distal portion of the contact portion 220b of the second contact 200b.

As illustrated in FIGS. 2A and 2B, the housing groove 154 is provided in the body 100, at a position on the first side of the first direction X relative to the connection hole 130. The housing groove 154 extends in the second direction Y and communicates with the connection hole 130. The housing groove 154 is slightly larger in dimension in the second direction Y than the fixed portion 210d of the fourth contact 200d. The housing groove 154 is slightly smaller in dimension in the third direction Z than the fixed portion 210d of the fourth contact 200d. The fixed portion 210d is press-fitted and held in the housing groove 154. The contact portion 220d of the fourth contact 200d is disposed in the connection hole 130 and faces the contact portion 220a of the first contact 200a.

As illustrated in FIGS. 2A and 2B, the housing groove 155 is provided in the body 100, at a position on the first side of the first direction X relative to the housing groove 154 with a space therebetween. The housing groove 155 extends in the second direction Y and communicates with the housing groove 154. The housing groove 155 is slightly larger in dimension in the second direction Y than the fixed portion 210e of the fifth contact 200e. The housing groove 155 is slightly smaller in dimension in the third direction Z than the fixed portion 210e of the fifth contact 200e. The fixed portion 210e is press-fitted and held in the housing groove 155.

As illustrated in FIGS. 2A and 3B, the housing hole 163 is provided in the body 100, at a position on the first side of the second direction Y (on the front side) relative to the housing grooves 154 and 155. The housing hole 163 is a horizontal hole extending in the second direction Y and communicating with the housing grooves 154 and 155 and the connection hole 130. The contact portion 220e of the fifth contact 200e is received in the housing hole 163. The distal portion of the contact portion 220e is received in the connection hole 130. The distal portion of the contact portion 220e is disposed on the first side of the second direction Y relative to the distal portion of the contact portion 220d of the fourth contact 200d and faces the distal portion of the contact portion 220c of the third contact 200c.

As illustrated in FIGS. 2A and 2B, the housing groove 156 is provided in the body 100, at a position on the first side of the first direction X relative to the housing groove 155 with a space therebetween. The housing groove 156 extends in the second direction Y and communicates with the housing groove 155. The housing groove 155 is slightly larger in dimension in the second direction Y than the fixed portion 210f of the sixth contact 200f. The housing groove 156 is slightly smaller in dimension in the third direction Z than the fixed portion 210f of the sixth contact 200f. The fixed portion 210f is press-fitted and held in the housing groove 156.

The housing hole 164 is provided in the body 100, at a position on the first side of the second direction Y (on the front side) relative to the housing groove 156. The housing hole 164 is a horizontal hole extending in the second direction Y and communicates with the housing groove 156 and the housing hole 163. The contact portion 220f of the sixth contact 200f is received in the housing holes 163 and 164. The distal portion of the contact portion 220f is disposed in the connection hole 130 and located on the first side of the second direction Y relative to the distal portion of the contact portion 220e of the fifth contact 200e.

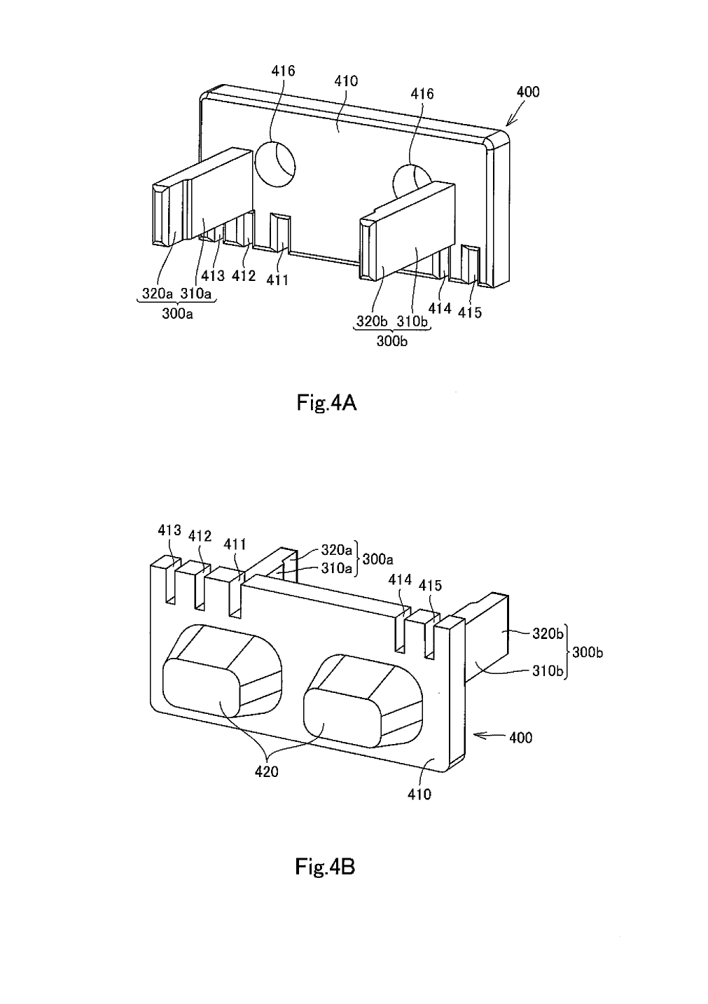

As illustrated in FIGS. 4A and 4B, the cover 400, the first stop 300a, and the second stop 300b are integrally formed of an insulating resin. The cover 400 includes a cover body 410 and a pair of projections 420. The cover body 410 is a rectangular plate. The outer shape of the cover body 410 conforms to the inner shape of the first fitting hole 141 of the body 100. The cover body 410 fittingly engages with the first fitting hole 141 so as to block a portion on the second side of the second direction Y of the connection hole 130.

Slits 411, 412, and 413 are provided, in spaced relation to each other along the first direction X, toward the second end in the first direction X of the lower portion of the cover body 410. The slits 411, 412, and 413 have dimensions in the first direction X that are substantially equal to those of the respective tails 230a, 230b, 230c of the first, second, and third contacts 200a, 200b, 200c. The slits 411, 412, and 413 have dimensions in the third direction Z that are substantially equal to those of the respective tails 230a, 230b, 230c. The slits 411, 412, and 413 have dimensions in the second direction Y that are smaller than those of the respective tails 230a, 230b, 230c. The tails 230a, 230b, and 230c partially fit in the slits 411, 412, 413, respectively, and project therefrom to the second side of the second direction Y.

Slits 414 and 415 are provided, in spaced relation to each other along the first direction X, toward the first end in the first direction X of the lower portion of the cover body 410. The slits 414 and 415 have dimensions in the first direction X that are substantially equal to those of the respective tails 230e, 230f of the fifth and sixth contacts 200e, 200f. The slits 414 and 415 have dimensions in the third direction Z that are substantially equal to those of the respective tails 230e and 230f. The slits 414 and 415 have dimensions in the second direction Y that are smaller than those of the respective tails 230e, 230f. The tails 230e and 230f partially fit in the slits 414 and 415, respectively, and project therefrom to the second side of the second direction Y.

A pair of recesses 416 is provided, in spaced relation to each other along the first direction X, in a central portion of a first end face in the second direction Y (inner face) of the cover body 410. The first end face of the cover body 410 is provided with the first and second stops 300a, 300b. The first and second stops 300a, 300b extend to the first side of the second direction Y. The first stop 300a includes a base 310a and an abuttable portion 320a, and the second stop 300b includes a base 310b and an abuttable portion 320b.

The base 310a is integrally connected to the cover body 410 and interposed between the fixed portions 210a, 210b of the first and second contacts 200a, 200b. In other words, the base 310a is in contact with the fixed portions 210a, 210b of the first and second contacts 200a, 200b. The abuttable portion 320a extends from the base 310a to the first side of the second direction Y and is located on the elastic deformation direction side of the contact portion 220a of the first contact 200a so as to be abuttable on the distal portion of the contact portion 220a. Specifically, the abuttable portion 320a faces the distal portion of the contact portion 220a through the hole 211a of the fixed portion 210a. The abuttable portion 320a is of different dimension in the first direction X from that of the base 310a. In the present embodiment, the abuttable portion 320a is smaller in dimension in the first direction X than the base 310a. This defines a displacement range of the distal portion of the contact portion 220a (a range between the initial position as shown in FIG. 2A and an abutment position in which the distal portion of the contact portion 220a abuts the abuttable portion 320d).

The base 310a is integrally connected to the cover body 410 and interposed between the fixed portions 210d, 210e of the fourth and fifth contacts 200d, 200e. In other words, the base 310b is in contact with the fixed portions 210d, 210e of the fourth and fifth contacts 200d, 200e. The abuttable portion 320b extends from the base 310b to the first side of the second direction Y and is located on the elastic deformation direction side of the contact portion 220d of the fourth contact 200d so as to be abuttable on the distal portion of the contact portion 220d. Specifically, the abuttable portion 320b faces the distal portion of the contact portion 220d through the hole 211d of the fixed portion 210d. The abuttable portion 320b is of different dimension in the first direction X from that of the base 310b. In the present embodiment, the abuttable portion 320b is smaller in dimension in the first direction X than the base 310b. This defines a displacement range of the distal portion of the contact portion 220d (a range between an initial position as shown in FIG. 2A and an abutment position in which the distal portion of the contact portion 220d abuts the abuttable portion 320d).

The pair of projections 420 of trapezoidal shape are arranged, in spaced relation to each other along the first direction X, on the second end face in the second direction Y (outer face) of the cover body 410.

The seal 500 is a resin (e.g., an epoxy resin or nylon-based insulating resin) which is filled in the second fitting hole 142 of the body 100 to overlie the cover 400. The projections 420 of the cover 400 are partially embedded in the central portion of the seal 500. The tails 230a, 230b, 230c, 230e, and 230f are partially embedded in a second end portion in the third direction Z (lower portion) of the seal 500. In other words, the tails 230a, 230b, 230c, 230e, and 230f pass through the seal 500 (see FIG. 2A).

The following describes in detail a method for manufacturing the connector C as described above. The body 100 and the first to sixth contacts 200a to 200f are prepared. The contact portion 220c of the third contact 200c is then inserted through the housing groove 153 of the body 100 into the housing holes 162 and 161, and the fixed portion 210c of the third contact 200c is pressed into the housing groove 153. At this point, the distal portion of the contact portion 220c is inserted through the housing holes 162 and 161 into the connection hole 130. Then, the contact portion 220b of the second contact 200b is inserted through the housing groove 152 of the body 100 into the housing hole 161, and the fixed portion 210b of the second contact 200b is pressed into the housing groove 152. At this point, the distal portion of the contact portion 220b is inserted through the housing hole 161 into the connection hole 130. Then, the fixed portion 210a of the first contact 200a is pressed into the housing groove 151 of the body 100. Accordingly, the contact portion 220a of the first contact 200a is inserted through the housing groove 151 into the connection hole 130 of the body 100. In this manner, the fixed portions 210a, 210b, 210c of the first, second, and third contacts 200a, 200b, 200c are held, in spaced relation to each other, at the positions in the body 100 which are on the second side of the first direction X relative to the connection hole 130, while the contact portions 220a, 220b, 220c of the first, second, and third contacts 200a, 200b, 200c are arranged in the connection hole 130, in spaced relation to each other along the second direction Y.

Similarly, the contact portion 220f of the sixth contact 200f is inserted through the housing groove 156 of the body 100 into the housing holes 164, 163, and the fixed portion 210f of the sixth contact 200f is pressed into the housing groove 156. At this point, the distal portion of the contact portion 220f is inserted through the housing holes 164, and 163 into the connection hole 130. Then, the contact portion 220e of the fifth contact 200e is inserted through the housing groove 155 of the body 100 into the housing hole 163, and the fixed portion 210e of the fifth contact 200e is pressed into the housing groove 155. At this point, the distal portion of the contact portion 220e is inserted through the housing hole 163 into the connection hole 130. Then, the fixed portion 210d of the fourth contact 200d is pressed into the housing groove 154 of the body 100. Accordingly, the contact portion 220d of the fourth contact 200d is inserted through the housing groove 154 into the connection hole 130 of the body 100. In this manner, the fixed portions 210d, 210e, 210f of the fourth, fifth, and sixth contacts 200d, 200e, 200f are held, in spaced relation to each other, at the positions in the body 100 that are on the first side of the first direction X relative to the connection hole 130, while the contact portions 220d, 220e, 220f of the fourth, fifth, and sixth contacts 200d, 200e, 200f are arranged in the connection hole 130, in spaced relation to each other along the second direction Y.

Then prepared are the cover 400, the first stop 300a, and the second stop 300b. The first stop 300a is then pushed into the space between the fixed portions 210a, 210b of the first and second contacts 200a, 200b. The base 310a of the first stop 300a is thus interposed between the fixed portions 210a, 210b, while the abuttable portion 320a is located on the elastic deformation direction side of the contact portion 220a of the first contact 200a so as to be abuttable on the contact portion 220a. The second stop 300b is also pushed into the space between the fixed portions 210d, 210e of the fourth and fifth contacts 200d, 200e. The base 310b of the second stop 300b is thus interposed between the fixed portions 210d, 210e, while the abuttable portion 320b is located on the elastic deformation direction side of the contact portion 220d of the fourth contact 200d so as to be abuttable on the contact portion 220d. In addition, the cover 400 is fitted to the first fitting hole 141 of the body 100.

At this point, the tails 230a, 230b, 230c of the first, second, and third contacts 200a, 200b, 200c partially fit in the respective slits 411, 412, and 413 of the cover 400 and project therefrom to the second side of the second direction Y. Also, the tails 230e, 230f of the fifth and sixth contacts 200e, 200f partially fit in the respective slits 414 and 415 and project therefrom to the second side of the second direction Y.

After that, the body 100, the first to sixth contacts 200a to 200f, the cover 400, and the first and second stops 300a and 300b are arranged inside a mold (not shown). Then, an insulating resin is filled into the second fitting hole 142 of the body 100. The insulating resin forms the seal 500 to overlie the cover body 410 of the cover 400. At this point, the projections 420 of the cover 400 are partially embedded in the insulating resin, and the tails 230a, 230b, 230c, 230e, and 230f are partially embedded in the insulating resin. Accordingly, the tails 230a, 230b, 230c, 230e, and 230f pass through the seal 500 in the second direction Y.

The following describes in detail a procedure to mount the connector C assembled as described above on a circuit board of an electronic device (not shown). First, the connector C is placed on the circuit board. At this point, the tails 230a, 230b, 230c, 230e of the first, second, third, and fifth contacts 200a, 200b, 200c, 200e are respectively brought into contact with electrodes of the circuit board. The tail 230f of the sixth contact 200f is brought into contact with an earth electrode of the circuit board. Then, the tails 230a, 230b, 230c, 230e of the first, second, third, and fifth contacts 200a, 200b, 200c, 200e are respectively connected by soldering to the electrodes of the circuit board. The tail 230f of the sixth contact 200f is connected by soldering to the earth electrodes of the circuit board. The connector C is thus mounted on the electronic device.

The following describes a procedure to connect a plug P to the connector C. First, the plug P is inserted into the connection hole 130 of the body 100 of the connector C as illustrated in FIGS. 6A and 6B. The distal portion of the plug P thus fits in the holding hole 171 of the holding part 170 of the connector C.

At this point, a first electrode (not shown) of the plug P is inserted into a space between the distal portion of the contact portion 220a of the first contact 200a and the distal portion of the contact portion 220d of the fourth contact 200d. The contact portion 220a of the first contact 200a, pressed by the first electrode of the plug P, elastically deforms to the second side of the first direction X (toward the second contact 200b). The distal portion of the contact portion 220a is accordingly displaced to the second side of the first direction X (toward the second contact 200b). At this point, the distal portion of the contact portion 220a does not abut on the abuttable portion 320a of the first stop 300a. The contact portion 220d of the fourth contact 200d, pressed by the first electrode of the plug P, elastically deforms to the first side of the first direction X (toward the fifth contact 200e). The distal portion of the contact portion 220d is accordingly displaced to the first side of the first direction X (toward the fifth contact 200e). At this point, the distal portion of the contact portion 220d does not abut on the abuttable portion 320b of the second stop 300b.

A second electrode (not shown) of the plug P makes elastic contact with the distal portion of the contact portion 220b of the second contact 200b. The contact portion 220b of the second contact 200b, pressed by the second electrode of the plug P, elastically deforms to the second side of the first direction X. The distal portion of the contact portion 220b is accordingly displaced to the second side of the first direction X. A third electrode (not shown) of the plug P is inserted into a space between the distal portion of the contact portion 220c of the third contact 200c and the distal portion of the contact portion 220e of the fifth contact 200e. The contact portion 220c of the third contact 200c, pressed by the third electrode of the plug P, elastically deforms to the second side of the first direction X. The distal portion of the contact portion 220c is accordingly displaced to the second side of the first direction X. The contact portion 220e of the fifth contact 200e, pressed by the third electrode of the plug P, elastically deforms to the first side of the first direction X. The distal portion of the contact portion 220e is accordingly displaced to the first side of the first direction X. The earth electrode (not shown) of the plug P makes elastic contact with the distal portion of the contact portion 320f of the sixth contact 300f. The contact portion 220f of the sixth contact 200f, pressed by the earth electrode of the plug P, elastically deforms to the first side of the first direction X. The distal portion of the contact portion 220f is accordingly displaced to the first side of the first direction X.

During or after insertion of the plug P into the connecting hole 130 of the connector C, the plug P may be pried to the first side of the first direction X. In this case, the distal portion of the plug P moves to the second side of the first direction X. The first electrode of the plug P accordingly presses the contact portion 220a of the first contact 200a to the second side of the first direction X, so that the contact portion 220a elastically deforms to the second side of the first direction X (toward the second contact 200b). The distal portion of the contact portion 220a is accordingly displaced to the second side of the first direction X (toward the second contact 200b), inserted into the hole 211a of the fixed portion 210a, and brought into abutment with the abuttable portion 320a of the first stop 300a. This suppresses displacement beyond the predetermined displacement range of the distal portion of the contact portion 220a.

During or after insertion of the plug P into the connecting hole 130 of the connector C, the plug P may be pried to the second side of the first direction X. In this case, the distal portion of the plug P moves to the first side of the first direction X. The first electrode of the plug P accordingly presses the contact portion 220d of the fourth contact 200d to the first side of the first direction X, so that the contact portion 220d elastically deforms to the first side of the first direction X (toward the fifth contact 200e). The distal portion of the contact portion 220d is accordingly displaced to the first side of the first direction X (toward the fifth contact 200e), inserted into the hole 211d of the fixed portion 210d, and brought into abutment with the abuttable portion 320b of the second stop 300b. This suppresses displacement beyond the predetermined displacement range of the distal portion of the contact portion 220d.

The connector C has the following technical features. First, it is possible to suppress plastic deformation of the contact portions 220a and 220d. This is because the contact portions 220a and 220d of the first and fourth contacts 200a, 200d are prevented from undergoing displacement beyond the predetermined displacement ranges by respectively abutting on the first and second stops 300a, 300b. Second, the connector C is hardly upsized although it is provided with the first and second stops 200a and 200b. This is because the first stop 300a is interposed between the first and second contacts 200a, 200b and the second stop 300b is interposed between the fourth and fifth contacts 200d, 200e. In addition, the first and second stops 300a, 300b contiguous with the cover 400 are arranged to respectively face the contact portions 220a, 220d through the respective holes 211a, 211d of the fixed portions 210a, 220d. It is therefore possible to suppress increase in dimension in the second direction Y (length dimension) of the first and second stops 300a, 300b although they are abuttable on the contact portions 220a, 220d, respectively. It is accordingly possible to suppress upsizing of the connector C.

Third, it is possible to prevent electrical connection between the first and second contacts 200a, 200b via the first stop 200a interposed therebetween. Further, it is possible to prevent electrical connection between the fourth and fifth contacts 200d, 200e via the second stop 200b interposed therebetween. This is because the first and second stops 200a, 200b are made of an insulating resin. Fourth, it is easy to mount the first and second stops 300a, 300b. The first and second stops 300a, 300b are integral with the cover 400. In conjunction with a step of fitting the cover 400 in the first fitting hole 141 of the body 100, it is possible to insert the first stop 300a into the space between the first and second contacts 200a, 200b and the second stop 300b into the space between the fourth and fifth contacts 200d, 200e.

Fifth, the connector C has improved waterproofing and dustproofing properties. This is because the cover 400 fittingly engages with the first fitting hole 141 of the body 100 and the seal 500 is filled in the second fitting hole 142. Sixth, the cover 400 has improved degree of adhesion to the seal 500 for the following reason. The cover 400 has increased contact areas with the seal 500 because the projections 420 of the cover 400 are embedded in the seal 500.

The connector C is not limited to the above embodiment and may be modified in any manner within the scope of claims. The following describes in details such modifications.

In the above embodiment, the fourth, fifth, and sixth contacts 200d, 200e, 200f are arranged, in spaced relation to each other, at the positions in the body 100 that are on the first side of the first direction X relative to the connection hole 130. Further, the first, second, and third contacts 200a, 200b, 200c are arranged, in spaced relation to each other, at the positions in the body 100 that are on the second side of the first direction X relative to the connection hole 130. However, these arrangements may be modified in any manner as long as the first and second contacts arranged in spaced relation to each other along the first direction. In other words, the third to sixth contacts may be omitted.

In the above embodiment, the first contact 200a includes the fixed portion 210a, the contact portion 220a, and the tail 230a. However, the first contact may be modified in any manner as long as it has a contact portion that is elastically deformable toward the second contact. In the above embodiment, the contact portion 220a of the first contact 200a is contiguous with the first edge of the hole 211a of the fixed portion 210a. However, the contact portion of the first contact is not limited thereto. For example, the contact portion of the first contact may be contiguous with an end in the second direction of the fixed portion and extends to the first side of the second direction with an inclination to the first side of the first direction. Alternatively, the contact portion of the first contact may be contiguous with the second edge of the hole of the fixed portion and extends to the first side of the second direction with an inclination to the first side of the first direction. The contact portion of the fourth contact may be modified in a similar manner to that of the first contact. The second to sixth contacts may be modified in shape in any manner.

In the embodiment and its variants as described above, the first stop 300a is interposed between the first and second contacts 200a, 200b, and the abuttable portion 320a of the first stop 300a is disposed so as to be abuttable on the contact portion 220a of the first contact 200a. However, the first stop may be modified in any manner as long as it has an insulation property, is interposed between the first and second contacts, and is disposed on the elastic deformation direction side of the contact portion of the first contact so as to be abuttable on this contact portion. In the above embodiment, the abuttable portion 320a is smaller in dimension in the first direction X than the base 310a. However, the abuttable portion may be of dimension in the first direction that is equal to that of the base. Alternatively, the abuttable portion may be larger in dimension in the first direction than the base.

In the embodiment and its variants as described above, the first stop 300a is provided integrally with the cover 400. However, the first stop may be separate from the cover. Such a separate first stop may be held directly between the first and second contacts so as to be securely positioned. Also, the first stop may be connected to a connection hole in the cover.

The second stop may be omitted. Alternatively, the second stop may be modified in a similar manner to the first stop. The connector of the invention may be provided with another stop or stops in addition to the first and second stops. For example, such a stop or stops may be interposed between the second and third contacts and/or between the fifth and sixth contacts. In this case, the stop(s) may be disposed on the elastic deformation direction side(s) of the contact portion(s) of the second contact and/or the fifth contact so as to be abuttable on the contact portion(s).

In the embodiment and its variants as described above, the cover 400 fittingly engages with the first fitting hole 141 of the body 100, and the seal 500 is filled in the second fitting hole 142 of the body 100. However, the cover and/or the seal may be omitted. Alternatively, the cover may be modified in any manner as long as it can fittingly engage with the first fitting hole.

In the embodiment and its variants as described above, the body 100 includes the main body 110, the projected part 120, the connection hole 130, the first and second fitting holes 141 and 142, the housing grooves 151, 152, 153, 154, 155 and 156, the housing holes 161, 162, 163 and 164, and the holding part 170. However, the body may be modified in any manner as long as it is adapted to hold the first contact and the second contact in spaced relation to each other along the first direction. For example, the first contact and the second contact may be embedded by insert molding in the body, in spaced relation to each other along the first direction. In this case, the body may be formed with a space to receive the first stop between the first contact and the second contact. Alternatively, the first and second contacts and the first stop may be insert-molded in the body.

In the embodiment and its variants as described above, the first fitting hole 141 is provided at a portion of the body 100 on the second side of the second direction Y relative to the connection hole 130, and the second fitting hole 142 is provided on the second side of the second direction Y relative to the first fitting hole 141. However, the first fitting hole and/or the second fitting hole may be omitted. When only the second fitting hole is omitted, the cover can fittingly engage with first fitting hole so as block a portion on the second side of the second direction of the connection hole. Also, the connection hole may extend through the body in the second direction. In this case, the cover may block a portion on the second side of the second direction of the connection hole. The seal may overlie a portion on the second side of the second direction of the body and also overlie the cover. It is possible to omit the cover and/or the seal modified in any of the above manners. The cover modified in any of the above manners may be provided separately from the first and second stops as described above.

It should be appreciated that the materials, shapes, dimensions, numbers, arrangements, and other configurations of the constituents of the connector of the above embodiment are described above by way of examples only and may be modified in any manner if they can achieve similar functions. In the above embodiment, the connector C is a jack connector. However, the connector C is applicable to connectors other than jack connectors, such as USB connectors, HDMI (registered trademark) connectors, optical connectors, and connectors for IC cards. In the above embodiment, the connector C is connectable to a plug as a mating connector. However, the mating connector of the invention may be any type of connector that is connectable to the connector of the invention. In the above embodiment, the first direction X is the widthwise direction of the connector C, the second direction Y is the lengthwise direction of the connector C, and the third direction Z is the heightwise direction of the connector C. However, the first, second, and third directions may be defined in any manner. For example, the first direction may be the heightwise direction of the connector, the second direction may be the lengthwise direction of the connector, and the third direction may be the widthwise direction of the connector.

### REFERENCE SIGNS LIST

100: body

110: main body

120: projection

130: connection hole

141: first fitting hole

142: second fitting hole

151 to 156: housing groove

161 to 164: housing hole

170: holding part
171: holding hole
200a: first contact

210a: fixed portion

220a: contact portion

230a: tail
200b: second contact

210b: fixed portion

220b: contact portion

230b: tail
200c: third contact

210c: fixed portion

220c: contact portion

230c: tail
200d: fourth contact

210d: fixed portion

220d: contact portion
200e: fifth contact

210e: fixed portion

220e: contact portion

230e: tail
200f: sixth contact

210f: fixed portion

220f: contact portion

230f: tail portion
300a: first stop

310a: base

320a: abuttable portion
300b: second stop

310b: base

320b: abuttable portion
400: cover

410: cover body

420: projection
500: seal

1. A connector comprising:
a first contact;
a second contact disposed in spaced relation to the first contact along a first direction; and
a first stop having an insulation property, wherein
the first contact includes a contact portion, the contact portion being elastically deformable toward the second contact, and
the first stop is disposed between the first and second contacts and on an elastic deformation side of the contact portion so as to be abuttable on the contact portion.

2. The connector according to claim 1, wherein
the first stop includes:
a base interposed between the first and second contacts, and
an abuttable portion contiguous with the base and disposed on the elastic deformation side of the contact portion so as to be abuttable on the contact portion, and
the abuttable portion has a dimension in the first direction that differs from that of the base.

3. The connector according to claim 1, further comprising a body, the body holding the first and second contacts in spaced relation to each other along the first direction.

4. The connector according to claim 3, further comprising a cover, wherein
the body has a connection hole extending in a second direction through the body, the second direction being orthogonal to the first direction,
the first stop is contiguous with the cover and extends to a first side of the second direction, and
the cover blocks a portion on a second side of the second direction of the connection hole.

5. The connector according to claim 3, further comprising a cover, wherein
the first stop is contiguous with the cover and extends to a first side of a second direction, the second direction being orthogonal to the first direction,
the body has:
a connection hole, and
a first fitting hole on a second side of the second direction relative to the connection hole, the first fitting hole communicating with the connection hole, and
the cover fittingly engages with the first fitting hole and blocks a portion on the second side of the second direction of the connection hole.

6. The connector according to claim 4, wherein
the first contact further includes a fixed portion, the fixed portion having a hole, and
the contact portion is contiguous with an edge of the hole of the fixed portion, the contact portion being elastically deformable toward the second contact so as to be received into the hole and abuttable on the first stop.

7. The connector according to claim 5, further comprising a seal, wherein
the body further has a second fitting hole on the second side of the second direction relative to the first fitting hole, the second fitting hole communicating with the first fitting hole, and
the seal is a resin being filled in the second fitting hole and overlying the cover.

8. The connector according to claim 7, wherein
the cover includes a projection projecting to the second side of the second direction, the projection being embedded in the seal.

9. The connector according to claim 4, further comprising:
a third contact;
a forth contact;
a fifth contact;
a sixth contact; and
a second stop having an insulation property, wherein
the second, third, fourth, fifth, and sixth contacts each include a contact portion,
the fourth, fifth, and sixth contacts are arranged, in spaced relation to each other along the first direction, at positions in the body that are on a first side of the first direction relative to the connection hole, and the contact portions of the fourth, fifth, and sixth contacts are arranged in the connection hole, in spaced relation to each other along the second direction,
the first, second, and third contacts are arranged, in spaced relation to each other along the first direction, at positions in the body that are on a second side of the first direction relative to the connection hole, and the contact portions of the first, second, and third contacts are arranged inside the connection hole, in spaced relation to each other along the second direction,
the contact portion of the fourth contact is elastically deformable toward the fifth contact, and
the second stop is disposed between the fourth contact and the fifth contact and on an elastic deformation side of the contact portion of the fourth contact so as to be abuttable on the contact portion of the fourth contact.

10. An electronic device comprising the connector according to claim 1.

11. The connector according to claim 2, further comprising a body, the body holding the first and second contacts in spaced relation to each other along the first direction.

12. The connector according to claim 11, further comprising a cover, wherein
the body has a connection hole extending in a second direction through the body, the second direction being orthogonal to the first direction,
the first stop is contiguous with the cover and extends to a first side of the second direction, and
the cover blocks a portion on a second side of the second direction of the connection hole.

13. The connector according to claim 11, further comprising a cover, wherein
the first stop is contiguous with the cover and extends to a first side of a second direction, the second direction being orthogonal to the first direction,
the body has:
a connection hole, and
a first fitting hole on a second side of the second direction relative to the connection hole, the first fitting hole communicating with the connection hole, and
the cover fittingly engages with the first fitting hole and blocks a portion on the second side of the second direction of the connection hole.

14. The connector according to claim 5, wherein
the first contact further includes a fixed portion, the fixed portion having a hole, and
the contact portion is contiguous with an edge of the hole of the fixed portion, the contact portion being elastically deformable toward the second contact so as to be received into the hole and abuttable on the first stop.

15. The connector according to claim 12, wherein
the first contact further includes a fixed portion, the fixed portion having a hole, and
the contact portion is contiguous with an edge of the hole of the fixed portion, the contact portion being elastically deformable toward the second contact so as to be received into the hole and abuttable on the first stop.

16. The connector according to claim 13, wherein
the first contact further includes a fixed portion, the fixed portion having a hole, and
the contact portion is contiguous with an edge of the hole of the fixed portion, the contact portion being elastically deformable toward the second contact so as to be received into the hole and abuttable on the first stop.

17. The connector according to claim 13, further comprising a seal, wherein
the body further has a second fitting hole on the second side of the second direction relative to the first fitting hole, the second fitting hole communicating with the first fitting hole, and
the seal is a resin being filled in the second fitting hole and overlying the cover.

18. The connector according to claim 17, wherein
the cover includes a projection projecting to the second side of the second direction, the projection being embedded in the seal.

19. The connector according to claim 5, further comprising:
a third contact;
a forth contact;
a fifth contact;
a sixth contact; and
a second stop having an insulation property, wherein
the second, third, fourth, fifth, and sixth contacts each include a contact portion,
the fourth, fifth, and sixth contacts are arranged, in spaced relation to each other along the first direction, at positions in the body that are on a first side of the first direction relative to the connection hole, and the contact portions of the fourth, fifth, and sixth contacts are arranged in the connection hole, in spaced relation to each other along the second direction,
the first, second, and third contacts are arranged, in spaced relation to each other along the first direction, at positions in the body that are on a second side of the first direction relative to the connection hole, and the contact portions of the first, second, and third contacts are arranged inside the connection hole, in spaced relation to each other along the second direction,
the contact portion of the fourth contact is elastically deformable toward the fifth contact, and
the second stop is disposed between the fourth contact and the fifth contact and on an elastic deformation side of the contact portion of the fourth contact so as to be abuttable on the contact portion of the fourth contact.

20. The connector according to claim 1, further comprising a body, the body having a connection hole extending in a second direction through the body, the second direction being orthogonal to the first direction, wherein
the first contact includes a fixed portion, said contact portion, and a tail,
the second contact includes a fixed portion, a contact portion, and a tail,
the first and second contacts are arranged, in spaced relation to each other along the first direction, at positions in the body that are on a side of the first direction relative to the connection hole, and the contact portions of the first and second contacts are arranged inside the connection hole, in spaced relation to each other along the second direction,
the first stop is separate from the body, the first stop including:
a base interposed between the first and second contacts and in contact with the fixed portions of the first and second contacts, and
an abuttable portion contiguous with the base and disposed on the elastic deformation side of the contact portion of the first contact so as to be abuttable on the contact portion of the first contact, and
the abuttable portion has a dimension in the first direction that differs from that of the base.
